(19) United States
(12) Patent Application Publication
(10) Pub. No.: US 2020/0001661 A1
(43) Pub. Date: Jan. 2, 2020

(54) PNEUMATIC TIRE

(71) Applicant: TOYO TIRE CORPORATION, Itami-shi (JP)

(72) Inventor: Masaaki Ohara, Itami-shi (JP)

(73) Assignee: TOYO TIRE CORPORATION, Itami-shi (JP)

(21) Appl. No.: 16/440,027

(22) Filed: Jun. 13, 2019

(30) Foreign Application Priority Data
Jun. 29, 2018 (JP) 2018-125199

(51) Int. Cl. B60C 11/13

(52) U.S. Cl. CPC B60C 11/1353; B60C 2011/1361

(57) ABSTRACT

A pneumatic tire includes, in a tread portion, a plurality of blocks formed by a plurality of main grooves extending in a tire circumferential direction and a plurality of lateral grooves extending in a tire width direction so as to intersect the main grooves. The lateral grooves each include a reinforcement region in which a plurality of projecting portions are formed at a groove bottom. In the reinforcement region, at least one projecting portion is arranged on any line extending in the tire circumferential direction.

### CROSS-REFERENCE TO RELATED APPLICATIONS

This application claims priority of Japanese Patent Application No. 2018-125199 filed on Jun. 29, 2018, the content of which is incorporated herein by reference.

### BACKGROUND OF THE INVENTION

### Technical Field

The present invention relates to a pneumatic tire.

### Related Art

Conventionally, there has been known a pneumatic tire in which a plurality of button-shaped stone ejectors are provided in each groove formed in a tread (see, for example, JP 3822337 B2).

However, in the conventional pneumatic tire, the projections formed in the groove are only stone ejectors for preventing pebbles and the like from getting stuck in the groove. In the region where the stone ejectors are formed, there are lines where the stone ejectors are not located when viewed in the tire circumferential direction. The distance (thickness) from the groove bottom to a belt as an internal component cannot be sufficiently secured on these lines, and cracks are liable to be generated in the tire circumferential direction. In addition, simply making the groove shallow and increasing the thickness of the groove will deteriorate the drainage property or the sludge discharge property.

An object of the present invention is to provide a pneumatic tire capable of suppressing generation and growth of cracks at a groove bottom while preventing deterioration of the drainage property and the sludge discharge property at a lateral groove.

### SUMMARY

As means for achieving the above object, the present invention provides a pneumatic tire including, in a tread portion, a plurality of blocks formed by a plurality of main grooves extending in a tire circumferential direction and a plurality of lateral grooves extending in a tire width direction so as to intersect the main grooves, wherein the lateral grooves each include a reinforcement region in which a plurality of projecting portions are formed at a groove bottom, and wherein, in the reinforcement region, at least one projecting portion is arranged on any line extending in the tire circumferential direction.

According to this configuration, the distance from the groove bottom to a belt can be secured on any of lines extending in the tire circumferential direction with the plurality of projecting portions provided in the reinforcement region. Therefore, it is possible to suppress generation and growth of cracks directed in the tire circumferential direction. Moreover, the plurality of projecting portions are provided, and hence the drainage property and the sludge discharge property do not deteriorate.

It is preferable that the reinforcement region is provided at an intermediate portion in the tire circumferential direction in the groove bottom of each of the lateral grooves.

According to this configuration, an effect of preventing wiping generated when the blocks partitioned in the circumferential direction by the lateral grooves are ground is maintained while minimizing deterioration of the drainage property and the sludge discharge property as compared with the configuration in which the reinforcement region is provided in the entire region, thereby being capable of effectively suppressing generation of cracks.

It is preferable that the groove bottom of each of the lateral grooves includes a bottom surface between blocks adjacent to each other in the tire circumferential direction, and curved surfaces connecting side surfaces of the blocks and the bottom surface, and that the projecting portions are provided on the bottom surface.

According to this configuration, it is possible to reduce the influences by deformation of the blocks at the time of grounding, and it is possible to more effectively prevent generation of cracks.

It is preferable that the reinforcement region is provided at an intermediate portion in the tire width direction in the groove bottom of each of the lateral grooves.

According to this configuration, it is possible to secure desired drainage property and sludge discharge property while enhancing the reinforcing function at the groove bottom.

It is preferable that, in the reinforcement region, at least one projecting portion is arranged on any line extending in the tire width direction.

According to this configuration, it is possible to suppress generation and growth of cracks in the tire width direction.

It is preferable that the blocks partitioning the lateral groove are shoulder blocks.

According to this configuration, it is possible to effectively prevent generation of cracks in the lateral groove formed between the portions of the shoulder blocks at which the deformation amount is the largest at the ground contact surface.

It is preferable that an outer surface of each of the shoulder blocks includes two curved surfaces having different curvature radii in a tire meridional section, and that the reinforcement region is located in a region extending in the tire circumferential direction including a boundary between the two curved surfaces.

According to this configuration, it is possible to effectively prevent generation of cracks in the lateral groove corresponding to the portions of the shoulder blocks at which the deformation amount is the largest.

It is preferable that the projecting portions formed in the reinforcement region include a protrusion extending in the tire width direction and a plurality of projections located on both sides of the protrusion.

According to this configuration, it is possible to secure the rubber thickness of the groove bottom from the belt by the projections arranged on both sides of the protrusion while ensuring the sludge discharge performance by the protrusion extending in the tire width direction. Further, the plurality of projections are provided, so that the drainage property when the tire is worn is maintained.

According to the present invention, with the plurality of projecting portions provided in the reinforcement region, it is possible to sufficiently secure the distance between the groove bottom of the lateral groove and the belt which is an internal component and to suppress the generation and growth of crack. Moreover, a plurality of projecting portions are provided, so that desired drainage property and sludge discharge property can be secured.

### BRIEF DESCRIPTION OF THE DRAWINGS

The foregoing and the other features of the present invention will become apparent from the following description and drawings of an illustrative embodiment of the invention in which:

FIG. 1 is a tire meridian partial sectional view of a pneumatic tire according to an embodiment of the present invention;

FIG. 2 is a development view for illustrating a part of a tread portion of the pneumatic tire illustrated in FIG. 1;

FIG. 3 is a perspective view of shoulder blocks and shoulder lateral grooves illustrated in FIG. 1;

FIG. 4 is a sectional view of the shoulder lateral groove illustrated in FIG. 1;

FIG. 5 is a plan view of projecting portions according to another embodiment;

FIG. 6 is a plan view of projecting portions according to another embodiment;

FIG. 7 is a plan view of projecting portions according to another embodiment;

FIG. 8 is a plan view of projecting portions according to another embodiment; and

FIG. 9 is a plan view of projecting portions according to another embodiment.

### DETAILED DESCRIPTION OF EMBODIMENTS

Hereinafter, embodiments of the present invention are described with reference to the attached drawings. It should be noted that the following description is merely exemplary in nature and is not intended to limit the present invention, an object for application, or a usage. In addition, the drawings are schematic, and ratios of dimensions and the like are different from actual ones.

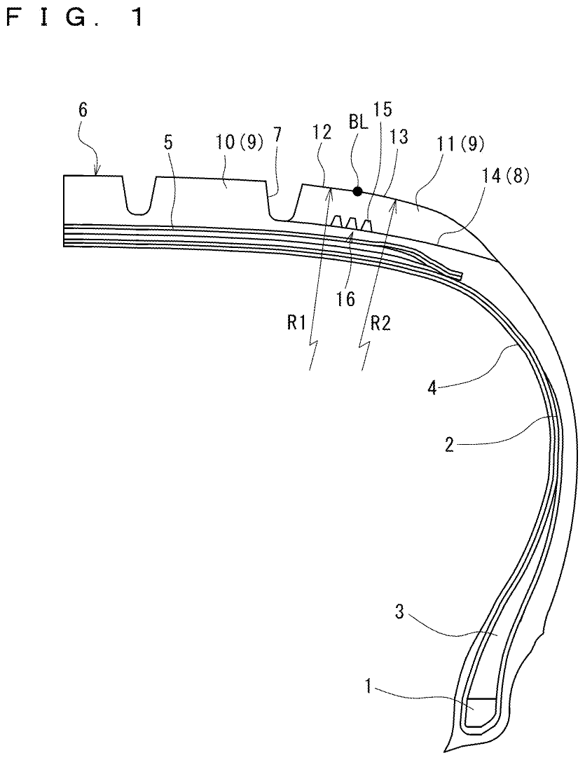

FIG. 1 is a meridian half sectional view of a pneumatic tire according to the present embodiment. The pneumatic tire has a carcass ply 2 stretched between a pair of bead cores 1. Both ends of the carcass ply 2 are wound up on the bead cores 1 and bead fillers 3 provided in connection with the bead cores 1. An inner liner 4 is provided inside the carcass ply 2. A plurality of belts 5 are wound around the outer peripheral side of the carcass ply 2. An outer peripheral side of the belts 5 is a tread portion 6.

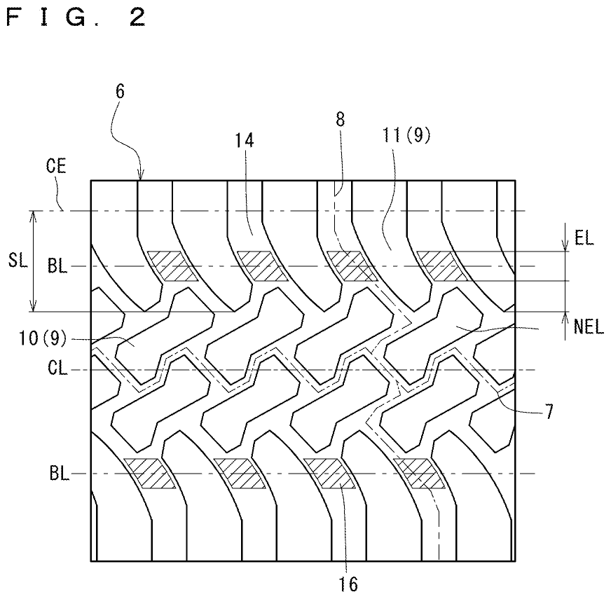

FIG. 2 is a development view for illustrating a part of the tread portion 6 of the pneumatic tire according to the present embodiment. The tread portion 6 has a plurality of blocks 9 formed by a plurality of main grooves 7 extending in the tire circumferential direction and a plurality of lateral grooves 8 extending in the tire width direction so as to intersect the main grooves 7. Here, the main groove 7 is formed in a zigzag shape, but can take various known forms such as a linear shape and a curved shape. Accordingly, simply description “tire circumferential direction” means generally the tire circumferential direction, and is understood in a broad concept including directions in which these various forms extend. Further, the lateral groove 8 can take various forms as the main groove 7, and simply description “tire width direction” means generally the tire width direction, and is understood in a broad concept including directions in which these various forms extend. The depths of the main groove 7 and the lateral groove 8 are the same.

The blocks 9 include a plurality of center blocks 10 arranged in two rows arranged along a tire equatorial plane CL and along the tire circumferential direction. In addition, the blocks 9 includes a plurality of shoulder blocks 11 arranged on the sides (both sides in the tire width direction) of the center blocks 10 along the tire circumferential direction.

The outer surface of the shoulder block 11 includes a first curved surface 12 whose outer surface in the tire meridian half sectional view illustrated in FIG. 1 is formed with a curvature radius R1 and a second curved surface 13 whose outer surface in the tire meridian half sectional view illustrated in FIG. 1 is formed with a curvature radius R2. As illustrated in FIGS. 2 and 3, a boundary line BL between the first curved surface 12 and the second curved surface 13 extends in the tire circumferential direction. The predetermined regions on both sides of the boundary line BL are portions of the shoulder blocks 11 at which the deformation amount is the largest.

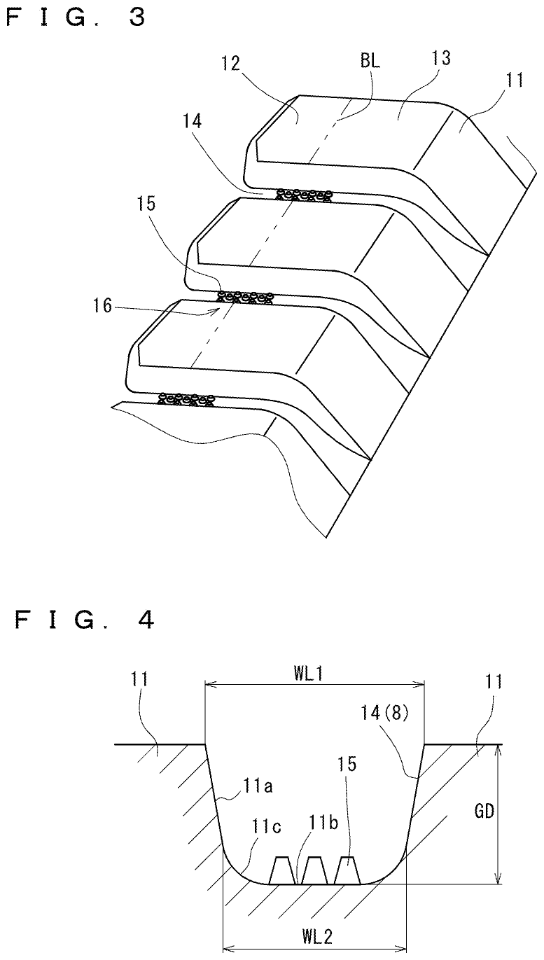

The lateral groove 8 (shoulder lateral groove 14) formed between the shoulder blocks 11 adjacent to each other in the tire circumferential direction is partitioned by side surfaces 11a of the shoulder blocks 11, a bottom surface 11b formed between the shoulder blocks 11, and curved surfaces 11c connecting the side surfaces 11a and the bottom surface 11b, as illustrated in FIG. 4. Here, the groove bottom of the shoulder lateral groove 14 includes the bottom surface 11b and the curved surfaces 11c. A groove depth GD of the shoulder lateral groove 14, that is, the distance in the tire radial direction from the outer surface to the bottom surface of the shoulder block 11 is set to 15 mm. Further, the groove width of the shoulder lateral groove 14, that is, the distance between the side surfaces of the shoulder blocks 11 adjacent to each other in the tire circumferential direction is set to 25 mm at an inter-upper-end distance WL1 of the side surfaces and 17 mm at an inter-upper-end distance WL2 of the lower curved surfaces on the lower side.

As illustrated in FIG. 3, a plurality of projections 15 are formed as projecting portions on the bottom surface of the shoulder lateral groove 14 to constitute a reinforcement region 16. The reinforcement region 16 occupies an intermediate portion of the shoulder lateral groove 14 in the tire width direction. Here, in the shoulder lateral groove 14, regions on both sides centering on the extension line of the boundary line BL correspond to the reinforcement regions 16. The reinforcement region 16 is a portion where bending stress is repeatedly applied when the shoulder block 11 is brought into contact with the ground or separated from the ground. By making the region including the boundary line BL as the reinforcement region 16, it is possible to reinforce the region at which the deformation amount is the largest at the time of the grounding.

As illustrated in FIG. 2, regarding the reinforcement region 16, a ratio EL/SL of a length EL of the reinforcement region 16 in the tire width direction to a length SL of the shoulder lateral groove 14 in the tire width direction is set to 15% to 65%, preferably 30% to 45%. The length SL of the shoulder lateral groove 14 means the shortest distance in the tire meridional section between the inner end of the shoulder block 11 in the tire width direction and a ground end position CE of the shoulder block 11. A ratio NEL/SL of a length NEL of the non-reinforcement region in the tire width direction to the length SL of the shoulder lateral groove 14 in the tire width direction is set to 20% to 40%, preferably 30% to 35%. If EL/SL<15%, the reinforcement is not sufficient, and if 65%<EL/SL, there is a concern about deterioration of the drainage property and the sludge discharge property.

Further, the reinforcement region 16 is located in the intermediate portion of the shoulder lateral groove 14 in the tire circumferential direction. Here, the reinforcement region 16 is provided on the groove bottom of the shoulder lateral groove 14, specifically, the bottom surface excluding the curved surface. By preventing the projections 15 from being formed on the curved surface, the problem that cracks are liable to be generated is avoided.

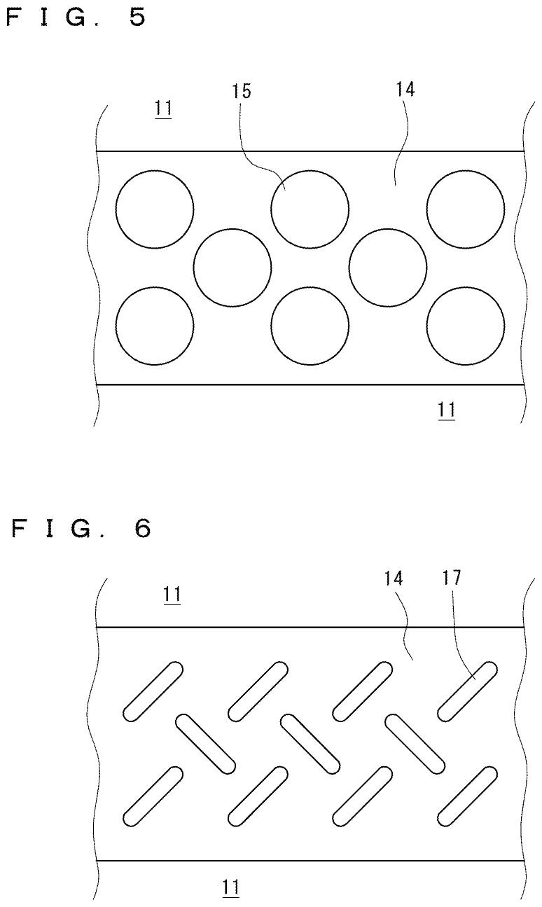

The projections 15 are formed in a truncated cone shape in which the cross-sectional area gradually decreases from the bottom surface toward the outer side in the tire radial direction. Here, each projection 15 is designed to have a diameter of 3 mm at the bottom surface, a diameter of 2 mm at the upper end surface, and a height of 2 mm. As illustrated in FIG. 5, the projections 15 are arranged in a staggered manner. Specifically, the projections 15 are arranged such that at least the bottom surface portions are located on any line extending in the tire circumferential direction in the reinforcement region 16. In addition, the projections 15 are arranged to be located on any line extending in the tire width direction in the reinforcement region 16. Furthermore, the projections 15 are designed to occupy 50% to 70% of the area of the reinforcement region 16 in a plan view. If it is less than 50%, the reinforcing function to prevent the generation of cracks and the like is not sufficient, and if it exceeds 70%, desired drainage property and sludge discharge property cannot be secured.

The pneumatic tire including the above-described reinforcement regions 16 can achieve the following effects.

By arranging the projections 15 in a staggered manner, the rigidity can be enhanced in a well-balanced manner as a whole. In addition, when the shoulder blocks 11 are brought into contact with the ground or separated from the ground, the stress is concentrated on the reinforcement regions 16, but the generation of the crack can be suppressed by the projections 15. Further, even if cracks are generated, growth of the cracks in the tire circumferential direction or the tire width direction can be suppressed by any of the projections 15 without fail.

Since the plurality of projections 15 are provided, the original depth of the shoulder lateral groove can be secured in the portion where the projections 15 are not formed. Therefore, even though the reinforcement regions 16 are provided, the drainage property or the sludge discharge property does not deteriorate even in a case of traveling on a wet road surface or a bad road.

When a green tire is vulcanized and molded, rubber is pushed away at the portion to be the shoulder lateral groove 14. In order to secure a desired thickness between the groove bottom and the belt 5, it is necessary to increase the amount of rubber in this portion. However, when the amount of rubber is increased, the rigidity of the tire in the rotational direction of the tire changes due to partial displacement of the belt 5 inward by the rubber pushed away during vulcanization molding. In addition, the thickness of the shoulder block 11 increases compared to an ideal value, which affects the durability, and also deteriorates the uniformity of the tire. By forming the plurality of projections 15, the amount of rubber to be pushed away can be reduced, and the occurrence of such a problem can be prevented.

It should be noted that the present invention is not limited to the configuration described in the embodiment described above, but includes various other modifications.

In the embodiment described above, the projections 15 have a truncated conical shape, but may have various shapes such as a cylindrical shape, a rectangular solid, a cube, a hemispherical shape, and the like.

In the embodiment described above, although the projections 15 are illustrated as an example of the projecting portions, the projecting portions may encompass an object having a certain length, an object having a shape which looks different in planar view, and the like. FIGS. 6 to 9 illustrate another example of the projecting portions.

FIG. 6 illustrates an example in which the projecting portions are constituted by a plurality of protrusions. The protrusions 17 are arranged to be inclined at 45° with respect to the tire width direction in which the shoulder lateral grooves 14 extend. The inclination directions of the protrusions 17 are different between the center portion of the shoulder lateral groove 14 in the width direction and the both side portions of the shoulder lateral groove 14 in the width direction. Similarly to the projections 15, the protrusions 17 are arranged to be located on any line even as viewed from either direction, specifically, the tire circumferential direction and the tire width direction.

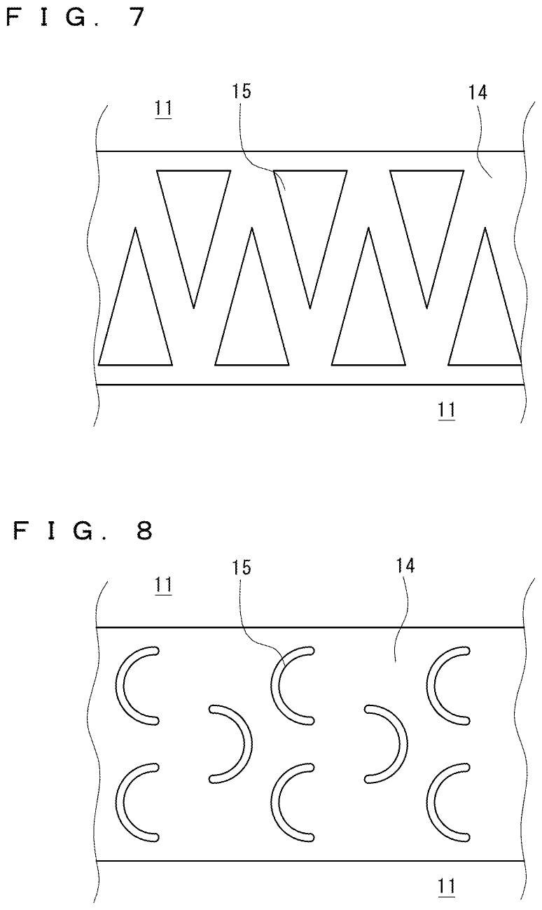

FIG. 7 illustrates an example in which the projecting portions are constituted by projections 15 having a triangular shape in plan view. The projections 15 are arranged in two rows in the shoulder lateral groove, and in each row, the positions of the projections 15 are shifted by one pitch, and the directions are reversed. Also in this example, the projections 15 are arranged to be located on any line even as viewed from either direction, specifically, the tire circumferential direction and the tire width direction.

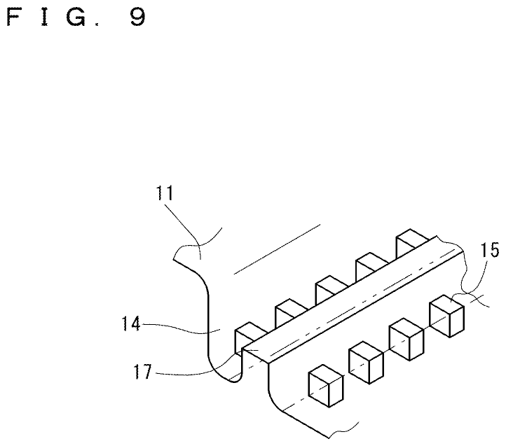

FIG. 8 illustrates an example in which the projecting portions are constituted by the projections 15 which are curved in a C-shape so as to open in one side. The projections 15 are arranged in three rows in the shoulder lateral groove, and the positions on the opening side are opposite to each other between the center portion and the both side portions. The projections at the center portion are open to the left in the figure, and the projections at both side portions (upper and lower in the drawing) are open to the right in the figure.

FIG. 9 illustrates an example in which the projecting portions are constituted by the protrusion 17 and the projections 15. The protrusion 17 extends across, in the tire width direction, the center portion of the shoulder lateral groove 14 in the width direction, and divides the shoulder lateral groove 14 into two parts in the tire circumferential direction. The projections 15 are arranged on both sides of the protrusion 17 and are formed in plural at predetermined intervals in the tire width direction.

According to the examples illustrated in FIGS. 6 to 9, in all cases, it is possible to prevent the growth of cracks generated in the circumferential direction by the projections 15 or the protrusions 17 and the crack length becomes shorter, so that it is also possible to suppress the growth of cracks in the groove depth direction.

In the embodiment described above, the shape and size of each projecting portion are the same, but either one or both may be different.

Although the case where the reinforcement region 16 is formed in the shoulder lateral groove 14 is described in the embodiment described above, the reinforcement region 16 may be formed in a center lateral groove formed between the center blocks 10 adjacent to each other in the tire circumferential direction. Further, in the case of a tire having a mediate block between the center block 10 and the shoulder block 11, it is also possible to form the reinforcement region 16 in a mediate lateral groove formed between the mediate blocks adjacent to each other in the tire circumferential direction. However, the reinforcement region 16 is most effective when formed in the shoulder lateral groove 14 between the portions of the shoulder blocks 11 at which the deformation amount is the largest when the tread portion 6 is brought into contact with the ground or separated from the ground.

What is claimed is:

1. A pneumatic tire comprising, in a tread portion, a plurality of blocks formed by a plurality of main grooves extending in a tire circumferential direction and a plurality of lateral grooves extending in a tire width direction so as to intersect the main grooves,
wherein the lateral grooves each include a reinforcement region in which a plurality of projecting portions are formed at a groove bottom, and
wherein, in the reinforcement region, at least one projecting portion is arranged on any line extending in the tire circumferential direction.

2. The pneumatic tire according to claim 1, wherein the reinforcement region is provided at an intermediate portion in the tire circumferential direction in the groove bottom of each of the lateral grooves.

3. The pneumatic tire according to claim 1,
wherein the groove bottom of each of the lateral grooves includes a bottom surface between blocks adjacent to each other in the tire circumferential direction, and curved surfaces connecting side surfaces of the blocks and the bottom surface, and
wherein the projecting portions are provided on the bottom surface.

4. The pneumatic tire according to claim 2,
wherein the groove bottom of each of the lateral grooves includes a bottom surface between blocks adjacent to each other in the tire circumferential direction, and curved surfaces connecting side surfaces of the blocks and the bottom surface, and
wherein the projecting portions are provided on the bottom surface.

5. The pneumatic tire according to claim 1, wherein the reinforcement region is provided at an intermediate portion in the tire width direction in the groove bottom of each of the lateral grooves.

6. The pneumatic tire according to claim 2, wherein the reinforcement region is provided at an intermediate portion in the tire width direction in the groove bottom of each of the lateral grooves.

7. The pneumatic tire according to claim 3, wherein the reinforcement region is provided at an intermediate portion in the tire width direction in the groove bottom of each of the lateral grooves.

8. The pneumatic tire according to claim 4, wherein the reinforcement region is provided at an intermediate portion in the tire width direction in the groove bottom of each of the lateral grooves.

9. The pneumatic tire according to claim 1, wherein at least one projecting portion is arranged on any line extending in the tire width direction in the reinforcement region.

10. The pneumatic tire according to claim 2, wherein at least one projecting portion is arranged on any line extending in the tire width direction in the reinforcement region.

11. The pneumatic tire according to claim 3, wherein, in the reinforcement region, at least one projecting portion is arranged on any line extending in the tire width direction.

12. The pneumatic tire according to claim 4, wherein, in the reinforcement region, at least one projecting portion is arranged on any line extending in the tire width direction.

13. The pneumatic tire according to claim 5, wherein, in the reinforcement region, at least one projecting portion is arranged on any line extending in the tire width direction.

14. The pneumatic tire according to claim 6, wherein, in the reinforcement region, at least one projecting portion is arranged on any line extending in the tire width direction.

15. The pneumatic tire according to claim 7, wherein, in the reinforcement region, at least one projecting portion is arranged on any line extending in the tire width direction.

16. The pneumatic tire according to claim 8, wherein, in the reinforcement region, at least one projecting portion is arranged on any line extending in the tire width direction.

17. The pneumatic tire according to claim 1, wherein the blocks partitioning the lateral groove are shoulder blocks.

18. The pneumatic tire according to claim 17,
wherein an outer surface of each of the shoulder blocks includes two curved surfaces having different curvature radii in a tire meridional section, and
wherein the reinforcement region is located in a region extending in the tire circumferential direction including a boundary between the two curved surfaces.

19. The pneumatic tire according to claim 1, wherein the projecting portions formed in the reinforcement region include a protrusion extending in the tire width direction and a plurality of projections located on both sides of the protrusion.
